(19) United States
(12) Patent Application Publication
(10) Pub. No.: US 2011/0196722 A1
(43) Pub. Date: Aug. 11, 2011

(54) MARKETPLACE FOR CAPTCHA DEVELOPERS

(75) Inventors: Kunal Punera, Mountain View, CA (US); Anirban Dasgupta, Berkeley, CA (US); Shanmugasundaram Ravikumar, Santa Clara, CA (US)

(73) Assignee: YAHOO! INC., Sunnyvale, CA (US)

(21) Appl. No.: 12/701,320

(22) Filed: Feb. 5, 2010

(51) Int. Cl. G06Q 50/00; G06F 15/16; G06F 9/44; G06Q 10/00; G06Q 30/00; H04L 29/06

(52) U.S. Cl. 705/14.11; 709/229; 717/131; 705/318; 726/4

(57) ABSTRACT

Techniques are described herein for providing a marketplace for CAPTCHA developers. A CAPTCHA is a type of challenge-response test that a content provider may present to users for authorizing the users to access content that is hosted by the content provider. CAPTCHA developers may propose CAPTCHAs for testing in the marketplace. A server is configured to provide instances of proposed CAPTCHAs to users along with instances of reference CAPTCHAs that have known difficulties to determine the relative difficulties of the proposed CAPTCHAs for the users. The server may determine a reward to be provided to a developer of a proposed CAPTCHA based on a difficulty that the predetermined automated systems encounter when they attempt to solve the proposed CAPTCHA and an ease with which the users solve the proposed CAPTCHA. The server may determine rewards to be provided to developers of predetermined automated systems that solve the proposed CAPTCHAs.

### BACKGROUND OF THE INVENTION

1. Field of the Invention

The present invention relates to a marketplace for CAPTCHA developers.

2. Background

A CAPTCHA is a type of challenge-response test that a content provider may present to users of a networked computer system for authorizing the users to access content that is hosted by the content provider. A content provider may be a webmail provider, a blog, a forum, a wiki, etc. For instance, a provider of a Web site may present a CAPTCHA to users who attempt to access the Web site, so that the provider may determine whether the users are humans or automated systems (a.k.a. bots). Automated systems often execute attacks that attempt to bypass the CAPTCHAs that are provided by content providers. If the automated systems are able to bypass the CAPTCHAs, the automated systems typically abuse the privileges that are offered by the content providers by sending SPAM emails, providing offensive posts, etc. and/or by consuming substantial resources of the content providers. Accordingly, such attacks typically degrade the quality of service of the content providers, which may result in monetary and/or reputational losses for the providers.

Incentives exist for the development of techniques that are capable of bypassing CAPTCHAs. For example, some companies offer software for sale that is purportedly capable of bypassing CAPTCHAs of targeted content providers. Other companies offer the services of humans for bypassing CAPTCHAs. However, relatively few incentives exist for the development of new CAPTCHAs. Furthermore, most of the innovation in the development of techniques for bypassing CAPTCHAs has come from relatively small groups of hackers and/or spammers. It therefore may be reasonable to presume that innovation in the development of new CAPTCHAs that are capable of resisting the attacks of automated systems may be led by individuals or small groups of developers. However, the development of new CAPTCHAs traditionally is handled by individual content providers, like Yahoo! Inc. and Google Inc., and companies, such as reCAPTCHA, that contract individually with content providers that subscribe to their CAPTCHA services.

Thus, systems, methods, and computer program products are needed that provide a marketplace in which developers are incentivized to develop new CAPTCHAs.

### BRIEF SUMMARY OF THE INVENTION

Various approaches are described herein for, among other things, providing a marketplace for CAPTCHA developers. A CAPTCHA is a type of challenge-response test that a content provider may present to users of a networked computer system for authorizing the users to access content that is hosted by the content provider. For example, a CAPTCHA may be a combination of characters (e.g., letters and/or numbers) that have been distorted in some manner. For instance, one or more of the characters may be stretched, twisted, compressed, rotated, blurred, obscured, closely spaced to another character, etc. In accordance with this example, when a CAPTCHA is provided to a user, the user may enter the characters of the CAPTCHA using an input device, such as a keyboard, touch screen, pointing device, etc., so that the user may obtain authorization to access content.

A CAPTCHA developer is an entity (e.g., one or more persons, one or more organizations, or a combination thereof) that develops a CAPTCHA. When a CAPTCHA developer provides a CAPTCHA to the marketplace, the CAPTCHA is referred to as a “proposed CAPTCHA”. Content providers may present proposed CAPTCHAs to users along with reference CAPTCHAs that have known difficulties to determine the relative difficulties of the proposed CAPTCHAs for the users.

Developers of automated systems may sign-up or be selected to develop automated systems that are capable of solving one or more proposed CAPTCHAs for the purpose of testing the resiliency of the proposed CAPTCHA(s) to attacks by automated systems. These automated systems are referred to as predetermined automated systems because the developers sometimes agree to develop such automated systems before (or shortly after) the proposed CAPTCHAs are provided to the users. Rewards may be provided to the CAPTCHA developers that develop the proposed CAPTCHA. In addition or alternatively, rewards may be provided to developers of automated systems that solve the proposed CAPTCHAs.

An example method is described in which instances of a proposed CAPTCHA and instances of a reference CAPTCHA are provided to users of a computer system. A first success rate is determined that indicates a proportion of the instances of the proposed CAPTCHA that is solved by the users. A second success rate is determined that indicates a proportion of the instances of the reference CAPTCHA that is solved by the users. The first success rate and the second success rate are compared to determine a relationship therebetween. A third success rate is determined that indicates a proportion of predetermined automated systems that solves the proposed CAPTCHA. A reward to be paid to a developer of the proposed CAPTCHA is determined based on the third success rate and the relationship between the first and second success rates.

A system is described that includes a provider module, a user success determination module, a comparison module, a “bot” success determination module, and a reward module. The provider module is configured to provide instances of a proposed CAPTCHA and instances of a reference CAPTCHA to users of a computer system. The user success determination module is configured to determine a first success rate that indicates a proportion of the instances of the proposed CAPTCHA that is solved by the users and a second success rate that indicates a proportion of the instances of the reference CAPTCHA that is solved by the users. The comparison module is configured to compare the first success rate and the second success rate to determine a relationship therebetween. The “bot” success determination module is configured to determine a third success rate that indicates a proportion of predetermined automated systems that solves the proposed CAPTCHA. The reward module is configured to determine a reward to be paid to a developer of the proposed CAPTCHA based on the third success rate and the relationship between the first and second success rates.

A computer program product is described that includes a computer-readable medium having computer program logic recorded thereon for enabling a processor-based system to provide a marketplace for CAPTCHA developers. The computer program logic includes first, second, third, and fourth program logic modules. The first program logic module is for enabling the processor-based system to provide instances of a proposed CAPTCHA and instances of a reference CAPTCHA to users of a computer system. The second program logic module is for enabling the processor-based system to determine a first success rate that indicates a proportion of the instances of the proposed CAPTCHA that is solved by the users and a second success rate that indicates a proportion of the instances of the reference CAPTCHA that is solved by the users. The third program logic module is for enabling the processor-based system to compare the first success rate and the second success rate to determine a relationship therebetween. The fourth program logic module is for enabling the processor-based system to determine a reward to be paid to a developer of the proposed CAPTCHA based on the relationship between the first and second success rates and further based on a third success rate that indicates a proportion of predetermined automated systems that solves the proposed CAPTCHA.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 depicts an example CAPTCHA.

FIG. 2 is a block diagram of an example computer system in accordance with an embodiment described herein.

FIGS. 3A-3C depict respective portions of a flowchart of a method for providing a marketplace for CAPTCHA developers in accordance with an embodiment described herein.

FIG. 4 is a block diagram of an example implementation of a server shown in FIG. 1 in accordance with an embodiment described herein.

FIG. 5 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments are capable of providing a marketplace for CAPTCHA developers. A CAPTCHA is a type of challenge-response test that a content provider may present to users of a networked computer system for authorizing the users to access content that is hosted by the content provider. For instance, the content provider may provide a randomly-selected or randomly-generated CAPTCHA to each user who attempts to access the content, though the scope of the example embodiments is not limited in this respect. The user is granted access to the content only if the user solves the CAPTCHA that is presented to the user.

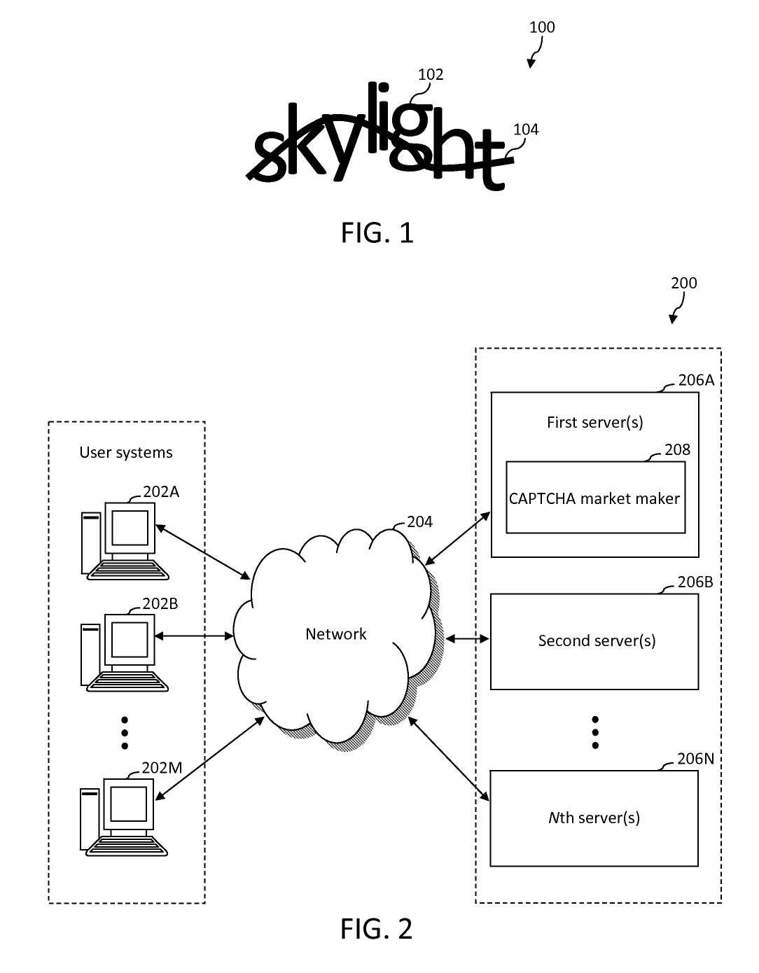

CAPTCHAs often are combinations of characters (e.g., letters and/or numbers) that have been distorted in some manner. For instance, one or more of the characters may be stretched, twisted, compressed, rotated, blurred, obscured, closely spaced to another character, etc. FIG. 1 depicts an example CAPTCHA 100 for illustrative purposes. CAPTCHA 100 is shown to include a word 102 that has a line 104 drawn through it. The word 102 shown in FIG. 1 is “skylight”. The letters of the word “skylight” are written in a wavy pattern, such that letters s-k-y-l are written in a star-step fashion upward, and the letters i-g-h-t are written in a stair-step fashion downward. Accordingly, the arrangement of the letters s-k-y-l-i-g-h-t resembles a wave or a hill. Line 104 curves such that line 104 intersects each of the letters s-k-y-l-i-g-h-t. When presented with CAPTCHA 100, a user may enter the characters s-k-y-l-i-g-h-t using an input device, such as a keyboard, touch screen, pointing device, etc., so that the user may obtain authorization to access desired content. CAPTCHA 100 is provided for illustrative purposes and is not intended to be limiting. It will be recognized that the embodiments described herein are applicable to any suitable CAPTCHA.

A CAPTCHA developer is an entity (e.g., one or more persons, one or more organizations, or a combination thereof) that develops a CAPTCHA. Example embodiments provide a marketplace in which CAPTCHA developers are incentivized to develop CAPTCHAs that are capable of resisting attacks that are initiated by automated systems (a.k.a. bots) but are solvable by humans without undue difficulty. The CAPTCHAs that CAPTCHA developers provide to the marketplace are referred to as “proposed CAPTCHAs”. Content providers may present the proposed CAPTCHAs to users along with reference CAPTCHAs that have known difficulties to determine the relative difficulties of the proposed CAPTCHAs for the users.

Developers of automated systems may sign-up or be selected to develop automated systems that are capable of solving one or more proposed CAPTCHAs for the purpose of testing the resiliency of the proposed CAPTCHA(s) to attacks by automated systems. The automated systems that are created by these developers are referred to as predetermined automated systems because the developers participate in a collaborative effort with content providers to develop such automated systems sometimes before (or shortly after) the proposed CAPTCHAs are provided to the users.

Rewards may be provided to the CAPTCHA developers that develop the proposed CAPTCHAs based on any of a variety of factors, such as the amount of time that the predetermined automated systems take to solve the proposed CAPTCHAs, the proportion of the predetermined automated systems that solves the proposed CAPTCHAs, the proportion of users that solves the proposed CAPTCHAs, the average time spent by the users to solve the CAPTCHAs, etc. In addition or alternatively, rewards may be provided to developers of automated systems that solve the proposed CAPTCHAs. For instance, such rewards may be based on a number of the predetermined automated systems that solve (or do not solve) the proposed CAPTCHAs.

Techniques described herein for providing a marketplace for CAPTCHA developers have a variety of benefits as compared to conventional techniques for marketing CAPTCHAs. For example, techniques may be capable of analyzing proposed CAPTCHAs upon receipt from CAPTCHA developers, so that only CAPTCHAs from trusted sources are used. The marketplace may provide a platform in which individual developers and small groups thereof may be rewarded for developing effective CAPTCHAs. Developers of predetermined automated systems may be rewarded for their efforts in solving such CAPTCHAs. The success of automated systems in solving CAPTCHAs may be continuously monitored, so that CAPTCHAs may be used less when they are solved more frequently by the automated systems.

### II. Example Embodiments for Providing a Marketplace for CAPTCHA Developers

FIG. 2 is a block diagram of an example computer system 200 in accordance with an embodiment described herein. Generally speaking, computer system 200 operates to provide information to users in response to requests (e.g., hypertext transfer protocol (HTTP) requests) that are provided by the users. The information may include Web pages, images, other types of files, output of executables, etc. Computer system 200 may provide CAPTCHAs to users who attempt to access such information in order to authorize the users to access the information. In accordance with example embodiments, computer system 200 operates to provide a marketplace in which developers are incentivized to develop new CAPTCHAs. Further detail regarding techniques for providing a marketplace for CAPTCHA developers is provided in the following discussion.

As shown in FIG. 2, computer system 200 includes a plurality of user systems 202A-202M, a network 204, and a plurality of servers 206A-206N. Communication among user systems 202A-202M and servers 206A-206N is carried out over network 204 using well-known network communication protocols. Network 204 may be a wide-area network (e.g., the Internet), a local area network (LAN), another type of network, or a combination thereof.

User systems 202A-202M are computers or other processing systems, each including one or more processors, that are capable of communicating with servers 206A-206N. User systems 202A-202M are capable of accessing sites (e.g., Web sites) hosted by servers 204A-204N, so that user systems 202A-202M may access information that is available via the sites. User systems 202A-202M are configured to provide requests (e.g., hypertext transfer protocol (HTTP) requests) to servers 206A-206N for requesting information stored on (or otherwise accessible via) servers 206A-206N. For instance, a user may initiate a request for information using a client (e.g., a Web crawler, a Web browser, a non-Web-enabled client, etc.) deployed on a user system 202 that is owned by or otherwise accessible to the user.

Servers 206A-206N are computers or other processing systems, each including one or more processors, that are capable of communicating with user systems 202A-202M. Servers 206A-206N are configured to host respective sites (e.g., Web sites), so that the sites are accessible to users of computer system 200. Servers 206A-206N are further configured to provide information to users in response to receiving requests (e.g., HTTP requests) from the users. Servers 206A-206N may be configured to provide CAPTCHAs to the users, so that the users may be authorized before the information is provided to the users. For instance, servers 206A-206N may provide the information to the users only if the users solve the CAPTCHAs that are provided to the users.

First server(s) 206A includes a CAPTCHA market maker 208. CAPTCHA market maker 208 is configured to provide CAPTCHAs to users who attempt to access information that is stored on (or otherwise accessible via) first server(s) 206A. CAPTCHA market maker 208 is further configured to provide a marketplace in which developers are incentivized to develop new CAPTCHAs. For example, a CAPTCHA developer may upload a proposed CAPTCHA to CAPTCHA market maker 208 using a client deployed on a user system 202 that is owned by or otherwise accessible to the CAPTCHA developer. CAPTCHA market maker 208 may be configured to determine whether the proposed CAPTCHA satisfies specified criteria. Assuming that the proposed CAPTCHA satisfies the specified criteria, CAPTCHA market maker 208 provides instances of the proposed CAPTCHA among user systems 202A-202M via network 204 when users thereof attempt to access information that is stored on (or otherwise accessible via) first server(s) 206A. The proposed CAPTCHAs may be provided to the users along with reference CAPTCHAs that have known difficulties, so that CAPTCHA market maker 208 may determine the relative difficulties of the proposed CAPTCHAs.

Predetermined automated systems may be included among user systems 202A-202M to assist CAPTCHA market maker 208 in determining the resiliency of proposed CAPTCHAs to attacks by bots. The predetermined automated systems execute software programs that are configured to solve the proposed CAPTCHAs when the proposed CAPTCHAs are received from CAPTCHA market maker 208. A developer of a predetermined automated system may be rewarded if the developer's automated system solves a proposed CAPTCHA. Such reward may be based on how many other predetermined automated systems solve (or do not solve) the proposed CAPTCHA, the time that the predetermined automated system takes to solve the proposed CAPTCHA, and so on.

A developer of a proposed CAPTCHA may be rewarded for providing a proposed CAPTCHA to the marketplace. Such reward may be based on any of a variety of factors, such as how successful the predetermined automated systems are at solving the proposed CAPTCHA, how difficult the proposed CAPTCHA is for humans to solve, etc. The success of the predetermined automated systems may be based on a proportion of the predetermined automated systems that solves the proposed CAPTCHA, a time that the predetermined automated systems take to solve the proposed CAPTCHA (e.g., an average time, a median time, a time that the first predetermined automated system to solve the proposed CAPTCHA takes, etc.), and so on. The difficulty of the proposed CAPTCHA for humans to solve may be based on the proportion of the users that solves the proposed CAPTCHA (e.g., in absolute terms or with respect to a known difficulty of a reference CAPTCHA), for example.

Automated systems that are not predetermined may be included among user systems 202A-202M. For example, such automated systems may be configured to bypass CAPTCHAs for the purpose of abusing the privileges that are offered by content providers. Upon identifying these automated systems, CAPTCHA market maker 208 may be configured to monitor whether the automated systems are capable of solving designated CAPTCHAs. For example, CAPTCHA market maker 208 may maintain a set of relatively difficult CAPTCHAs. In accordance with this example, the set of difficult CAPTCHAs may be used only for evaluation of the automated systems, though the scope of the example embodiments is not limited in this respect. The difficult CAPTCHAs may be provided to user systems 202A-202M along with a CAPTCHA that is designated to be tested (i.e., a test CAPTCHA). CAPTCHA market maker 208 may be configured to determine that user systems that consistently are unable to solve the difficult CAPTCHAs are automated systems, on which the test CAPTCHA may be tested.

Different content providers (e.g., Yahoo! Inc., Google Inc., Microsoft Corporation, etc.) or properties thereof (e.g., Yahoo!® Mail, Yahoo! ® Messenger, etc.) may have different needs for CAPTCHAs and/or may encounter different types of attacks from automated systems. Accordingly, the reward that a content provider or property thereof is willing to pay for a CAPTCHA may be based on the particular circumstances of that content provider or property.

First server(s) 206A is shown to include CAPTCHA market maker 208 for illustrative purposes. It will be recognized that any one or more of servers 206A-206N may include a CAPTCHA market maker, such as CAPTCHA market maker 208. It will be further recognized that any one or more user systems 202A-202M may communicate with any one or more servers 206A-206N. Although user systems 202A-202M are depicted as desktop computers in FIG. 2, persons skilled in the relevant art(s) will appreciate that user systems 202A-202M may include any client-enabled system or device, including but not limited to a laptop computer, a personal digital assistant, a cellular telephone, etc.

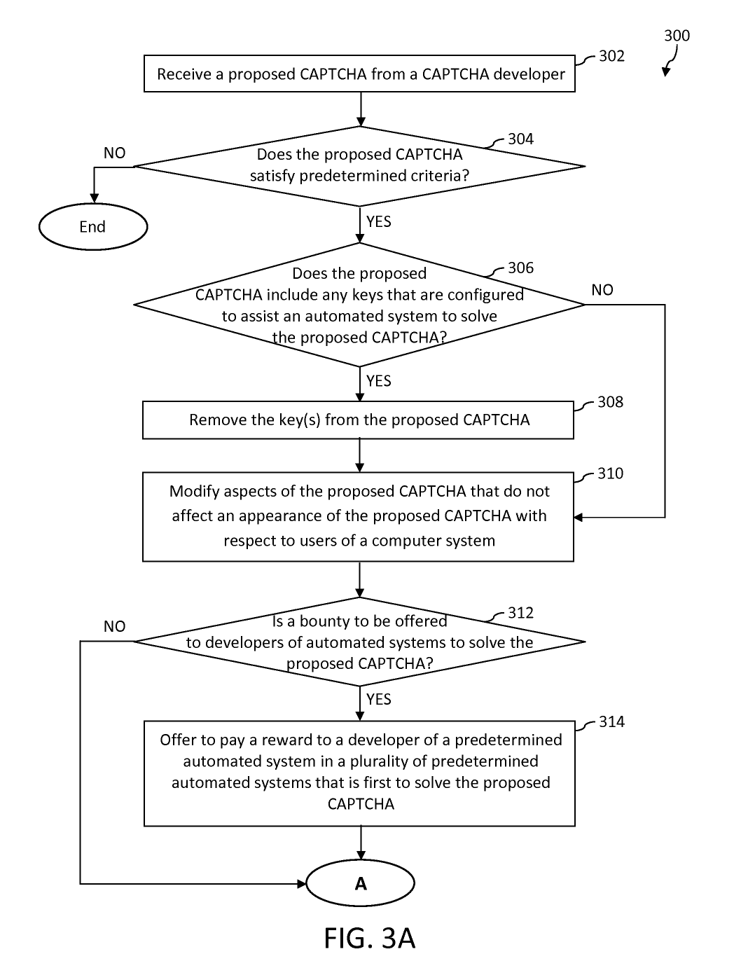

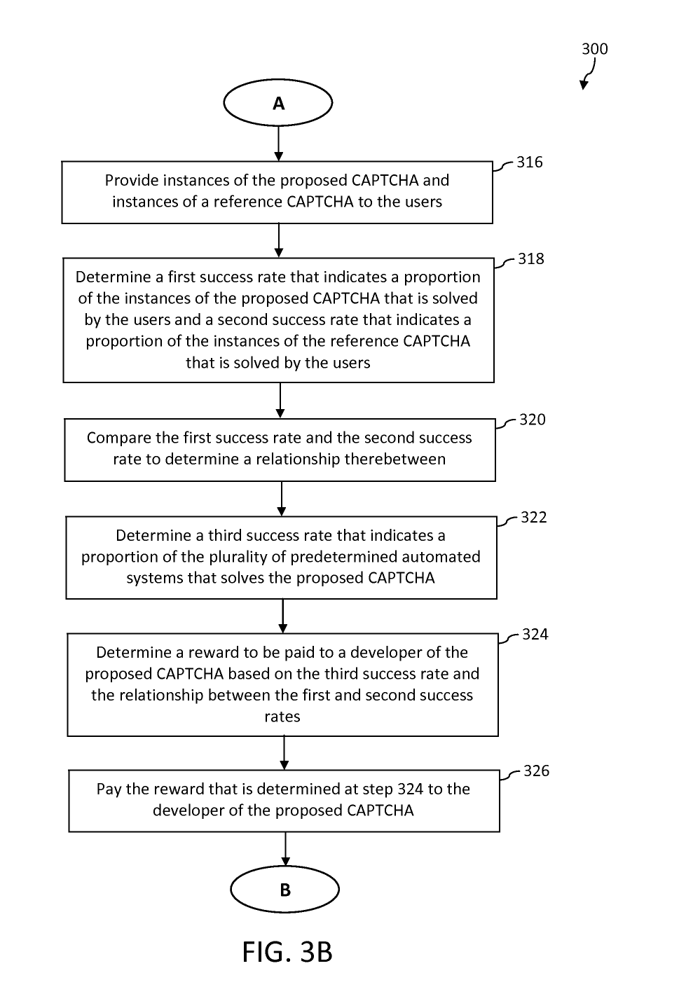

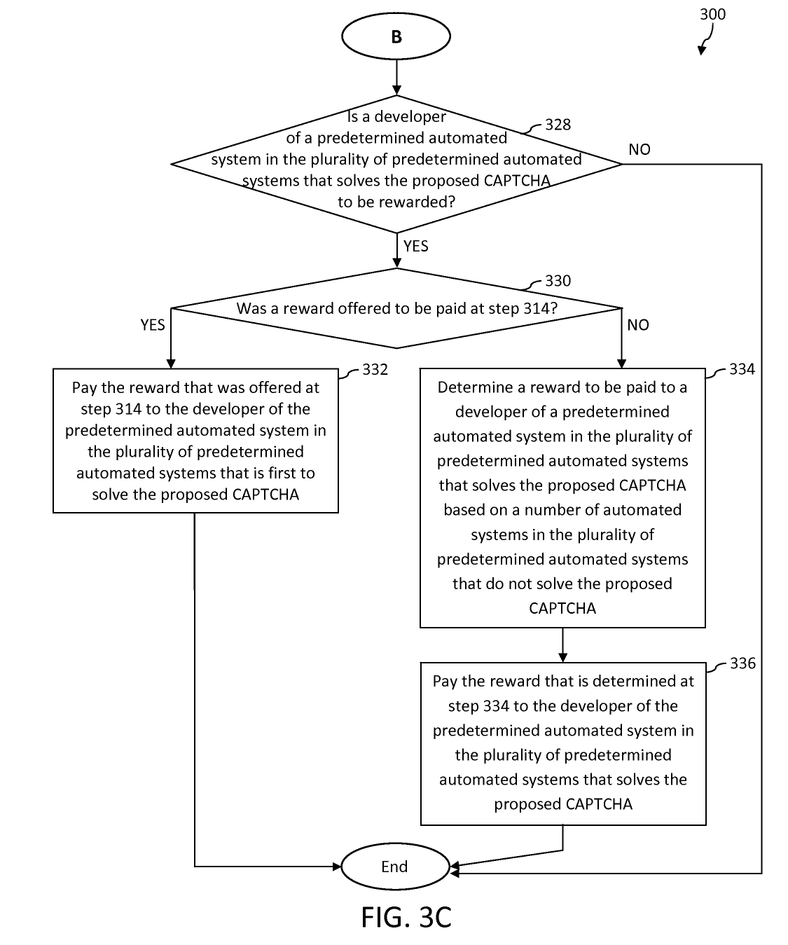

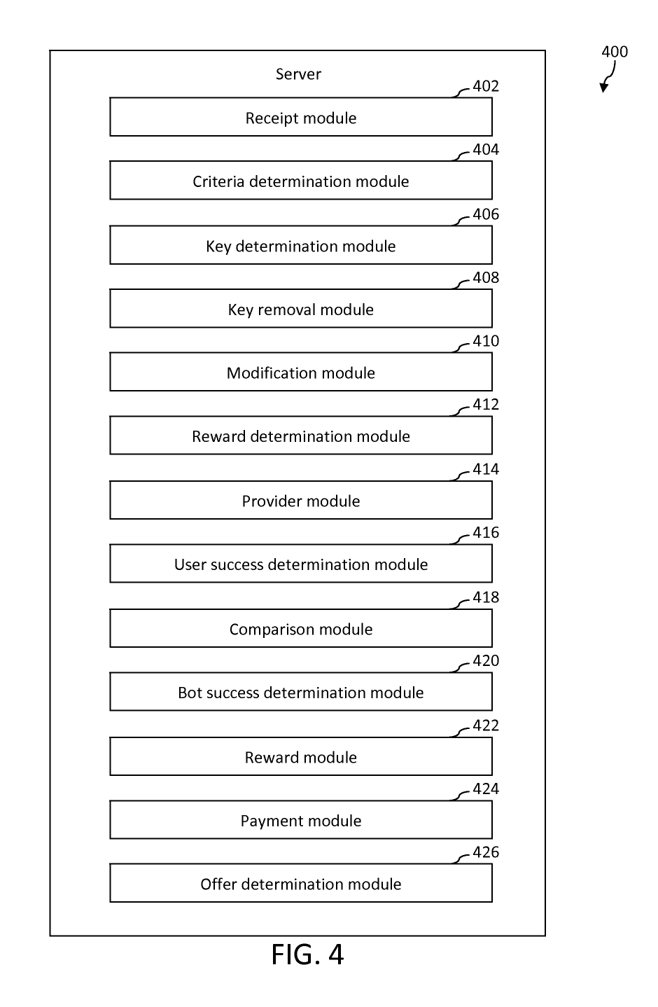

FIGS. 3A-3C depict respective portions of a flowchart 300 of a method for providing a marketplace for CAPTCHA developers in accordance with an embodiment described herein. Flowchart 300 may be performed by any one or more of servers 206A-206N of computer system 200 shown in FIG. 2, for example. For illustrative purposes, flowchart 300 is described with respect to a server 400 shown in FIG. 4, which is an example of a server 206, according to an embodiment. As shown in FIG. 4, server 400 includes a receipt module 402, a criteria determination module 404, a key determination module 406, a key removal module 408, a modification module 410, a compensation determination module 412, a provider module 414, a user success determination module 416, a comparison module 418, a bot success determination module 420, a reward module 422, a payment module 424, and an offer determination module 426. Further structural and operational embodiments will be apparent to persons skilled in the relevant art(s) based on the discussion regarding flowchart 300. Flowchart 300 is described as follows.

As shown in FIG. 3A, the method of flowchart 300 begins at step 302. In step 302, a proposed CAPTCHA is received from a CAPTCHA developer. In an example implementation, receipt module 402 receives the proposed CAPTCHA. For instance, the CAPTCHA developer may upload the proposed CAPTCHA to receipt module 402 via a network, such as network 204 of FIG. 2.

At step 304, a determination is made whether the proposed CAPTCHA satisfies predetermined criteria. Some examples of a predetermined criterion include but are not limited to a file size of the proposed CAPTCHA, dimensions of the proposed CAPTCHA, load time of the proposed CAPTCHA, type of user input accepted by the CAPTCHA (e.g., clicking, text entry, etc.), the probability of solving the proposed CAPTCHA using random guesses, cultural sensitivity of the proposed the CACAPTCHA, an average time for a sample of humans to solve the proposed CAPTCHA, etc. In an example implementation, criteria determination module 404 determines whether the proposed CAPTCHA satisfies the predetermined criteria. If the proposed CAPTCHA satisfies the predetermined CAPTCHA, flow continues to step 306. Otherwise, flowchart 300 ends.

At step 306, a determination is made whether the proposed CAPTCHA includes any keys that are configured to assist an automated system to solve the proposed CAPTCHA. For example, the developer of the proposed CAPTCHA may collude with a developer of a predetermined automated system and hide key(s) in the proposed CAPTCHA, so that the predetermined automated system can retrieve the key(s) and solve the proposed CAPTCHA. In another example, the developer of the proposed CAPTCHA may develop a predetermined automated system that is configured to retrieve the key(s) and to solve the proposed CAPTCHA. The key(s) may be hidden in a particular pixel of the proposed CAPTCHA, in metadata of the proposed CAPTCHA, in the name of the proposed CAPTCHA, or in any other aspect of the proposed CAPTCHA. In an example implementation, key determination module 406 determines whether the proposed CAPTCHA includes any keys that are configured to assist an automated system to solve the proposed CAPTCHA. If the proposed CAPTCHA includes any such keys, flow continues to step 308. Otherwise, flow continues to step 310.

At step 308, the key(s) are removed from the proposed CAPTCHA. In an example implementation, key removal module 408 removes the keys from the proposed CAPTCHA.

At step 310, aspects of the proposed CAPTCHA that do not affect an appearance of the proposed CAPTCHA are modified with respect to users of a computer system. For example, these aspects may be modified as a precautionary measure in case such aspects include keys that were not discovered in step 306. In accordance with this example, a predetermined automated system may be less likely to find a key in the proposed CAPTCHA if modifying the aspects changes the location of the key in the proposed CAPTCHA. In an example implementation, modification module 410 modifies the aspects of the proposed CAPTCHA.

At step 312, a determination is made whether a bounty is to be offered to developers of automated systems to solve the proposed CAPTCHA. In an example implementation, reward determination module 412 determines whether a bounty is to be offered to developers of automated systems to solve the proposed CAPTCHA. For example, a flag that is associated with the proposed CAPTCHA may be set to a first state if a bounty is to be offered, and the flag may be set to a second state if no bounty is to be offered. In accordance with this example, reward determination module 412 may interpret the flag to determine whether a bounty is to be offered. If a bounty is to be offered, flow continues to step 314. Otherwise, flow continues to step 316, which is shown in FIG. 3B.

At step 314, an offer is made to pay a reward to a developer of a predetermined automated system in a plurality of predetermined automated systems that is first to solve the proposed CAPTCHA. For example, the offer may specify that the reward is a predetermined amount (i.e., an amount having no contingencies for which an outcome is unknown at the time the offer is made). In another example, the offer may specify that the reward increases with passage of time so long as the proposed CAPTCHA is not solved by a predetermined automated system. For instance, the offer may specify that the reward is $10,000 if the proposed CAPTCHA is solved by a predetermined automated system within the first month, $20,000 if the proposed CAPTCHA is solved by a predetermined automated system during the second month, and so on. These example reward specifications are provided for illustrative purposes and are not intended to be limiting. It will be recognized that the offer may specify any suitable reward amount regarding any suitable time period(s). In an example implementation, provider module 414 offers to pay the reward to the developer of the predetermined automated system that is first to solve the proposed CAPTCHA.

At step 316, instances of the proposed CAPTCHA and instances of a reference CAPTCHA are provided to the users. In an example implementation, provider module 414 provides the instances of the proposed CAPTCHA and the instances of the reference CAPTCHA to the users. For instance, provider module 414 may provide the instances of the proposed CAPTCHA and the instances of the reference CAPTCHA to the users when the users attempt to access content that is hosted by server 400.

At step 318, a first success rate and a second success rate are determined. The first success rate indicates a proportion of the instances of the proposed CAPTCHA that is solved by the users. The second success rate indicates a proportion of the instances of the reference CAPTCHA that is solved by the users. In an example implementation, user success determination module 416 determines the first and second success rates.

At step 320, the first success rate and the second success rate are compared to determine a relationship therebetween. For example, the first and second success rates may be compared to determine that the first success rate is less than, substantially the same as, or greater than the second success rate. In accordance with this example, it may be desirable for the proposed CAPTCHA not to be substantially more difficult than the reference CAPTCHA for the users to solve. Accordingly, it may be desirable for the first success rate to be substantially the same as or greater than the second success rate. In an example implementation, comparison module 418 compares the first and second success rates to determine the relationship therebetween.

At step 322, a third success rate is determined that indicates a proportion of the plurality of predetermined automated systems that solves the proposed CAPTCHA. In an example implementation, bot success determination module 420 determines the third success rate.

At step 324, a reward to be paid to a developer of the proposed CAPTCHA is determined based on the third success rate and the relationship between the first and second success rates. For example, a relatively greater third success rate may weigh in favor of a lesser reward; whereas, a lesser third success rate may weigh in favor of a greater reward. In another example, a greater first success rate with reference to the second success rate may weigh in favor of a greater reward; whereas, a lesser first success rate with reference to the second success rate may weigh in favor of a lesser reward. The reward that is to be paid to the developer of the proposed CAPTCHA may be a purchase price for which the developer relinquishes all rights in the proposed CAPTCHA, a licensing fee for which the developer retains ownership of the proposed CAPTCHA, or any other type of reward. In an example implementation, reward module 422 determines the reward to be paid to the developer of the proposed CAPTCHA.

In an example embodiment, factor(s) in addition to or in lieu of the third success rate and/or the relationship between the first and second success rates may be taken into consideration to determine the reward to be paid to the developer of the proposed CAPTCHA.

At step 326, the reward that is determined at step 324 is paid to the developer of the proposed CAPTCHA. In an example implementation, payment module 424 pays the reward that is determined at step 324 to the developer of the proposed CAPTCHA. For instance, payment module 424 may wire the reward to an account of the developer of the proposed CAPTCHA, generate a check to be delivered to the developer of the proposed CAPTCHA, etc. Upon completion of step 326, flow continues to step 328, which is shown in FIG. 3C.

At step 328, a determination is made whether a developer of a predetermined automated system in the plurality of predetermined automated systems that solves the proposed CAPTCHA is to be rewarded. In an example implementation, reward determination module 412 determines whether a developer of a predetermined automated system that solves the proposed CAPTCHA is to be rewarded. For example, a flag may be set to a first state if a developer of a predetermined automated system that solves the proposed CAPTCHA is to be rewarded. In accordance with this example, the flag may be set to a second state if the developer is not to be rewarded. In further accordance with this example, reward determination module 412 may interpret the flag to determine whether the developer is to be rewarded. If a developer of a predetermined automated system that solves the proposed CAPTCHA is to be rewarded, flow continues to step 330. Otherwise, flowchart 300 ends.

At step 330, a determination is made whether a reward was offered to be paid at step 314. In an example implementation, offer determination module 426 determines whether a reward was offered to be paid at step 314. For instance, offer determination module 426 may determine whether a reward was offered to be paid based on a state of a flag. If a reward was offered to be paid at step 314, flow continues to step 332. Otherwise, flow continues to step 334.

At step 332, the reward that was offered at step 314 is paid to the developer of the predetermined automated system in the plurality of predetermined automated systems that is first to solve the proposed CAPTCHA. In an example implementation, payment module 424 pays the reward that was offered at step 314 to the developer of the predetermined automated system that is first to solve the proposed CAPTCHA. Upon completion of step 332, flowchart 300 ends.

At step 334, a reward to be paid to a developer of a predetermined automated system in the plurality of predetermined automated systems that solves the proposed CAPTCHA is determined based on a number of automated systems in the plurality of predetermined automated systems that do not solve the proposed CAPTCHA. For example, if there are fifteen predetermined automated systems, and four of the predetermined automated systems fail to solve the proposed CAPTCHA, the reward to be paid to a developer of a predetermined automated system that solves the proposed CAPTCHA may be based on four or 4/15 of the predetermined automated systems failing to solve the proposed CAPTCHA (i.e., eleven or 11/15 of the predetermined automated systems solving the proposed CAPTCHA). In an example implementation, reward module 422 determines the reward to be paid to a developer of a predetermined automated system that solves the proposed CAPTCHA.

In an example embodiment, factor(s) in addition to or in lieu of the number of automated systems that do not solve the proposed CAPTCHA may be taken into consideration to determine the reward to be paid to the developer of the predetermined automated system that solves the proposed CAPTCHA.

At step 336, the reward that is determined at step 334 is paid to the developer of the predetermined automated system in the plurality of predetermined automated systems that solves the proposed CAPTCHA. In the example described above with reference to step 334, the reward that is determined at step 334 may be paid to each of the eleven developers of the respective predetermined automated systems. Alternatively, the reward may be divided among the eleven developers. In another alternative, the reward may be paid to only the developer of the first predetermined automated system to solve the proposed CAPTCHA. In an examples implementation, payment module 424 pays the reward that is determined at step 334 to the developer of the predetermined automated system that solves the proposed CAPTCHA. Upon completion of step 336, flowchart 300 ends.

In accordance with an example embodiment, bids are solicited from CAPTCHA developers. In an example implementation, provider module 314 solicits the bids. Each bid specifies how much the respective developer wants to charge for each use of the developer's proposed CAPTCHA. For example, the bid that is submitted by the developer of the proposed CAPTCHA that is discussed in flowchart 300 may be taken into consideration at step 324 above to determine the reward to be paid to the developer of that proposed CAPTCHA.

In some example embodiments, one or more steps 302, 304, 306, 308, 310, 312, 314, 316, 318, 320, 322, 324, 326, 328, 330, 332, 334, and/or 336 of flowchart 300 may not be performed. Moreover, steps in addition to or in lieu of steps 302, 304, 306, 308, 310, 312, 314, 316, 318, 320, 322, 324, 326, 328, 330, 332, 334, and/or 336 may be performed.

It will be recognized that server 400 may not include one or more of receipt module 402, criteria determination module 404, key determination module 406, key removal module 408, modification module 410, reward determination module 412, provider module 414, user success determination module 416, comparison module 418, bot success determination module 420, reward module 422, payment module 424, and/or offer determination module 426. Furthermore, server 400 may include modules in addition to or in lieu of receipt module 402, criteria determination module 404, key determination module 406, key removal module 408, modification module 410, reward determination module 412, provider module 414, user success determination module 416, comparison module 418, bot success determination module 420, reward module 422, payment module 424, and/or offer determination module 426. Moreover, server 400 may be implemented as one or more servers.

It should be noted that CAPTCHA market maker 208 of FIG. 2 may include receipt module 402, criteria determination module 404, key determination module 406, key removal module 408, modification module 410, reward determination module 412, provider module 414, user success determination module 416, comparison module 418, bot success determination module 420, reward module 422, payment module 424, and/or offer determination module 426 of FIG. 4, or any portion or combination thereof, for example, though the scope of the embodiments is not limited in this respect.

CAPTCHA market maker 208, receipt module 402, criteria determination module 404, key determination module 406, key removal module 408, modification module 410, reward determination module 412, provider module 414, user success determination module 416, comparison module 418, bot success determination module 420, reward module 422, payment module 424, and offer determination module 426 may be implemented in hardware, software, firmware, or any combination thereof.

For example, CAPTCHA market maker 208, receipt module 402, criteria determination module 404, key determination module 406, key removal module 408, modification module 410, reward determination module 412, provider module 414, user success determination module 416, comparison module 418, bot success determination module 420, reward module 422, payment module 424, and/or offer determination module 426 may be implemented as computer program code configured to be executed in one or more processors.

In another example, CAPTCHA market maker 208, receipt module 402, criteria determination module 404, key determination module 406, key removal module 408, modification module 410, reward determination module 412, provider module 414, user success determination module 416, comparison module 418, bot success determination module 420, reward module 422, payment module 424, and/or offer determination module 426 may be implemented as hardware logic/electrical circuitry.

### III. Example Computer Implementation

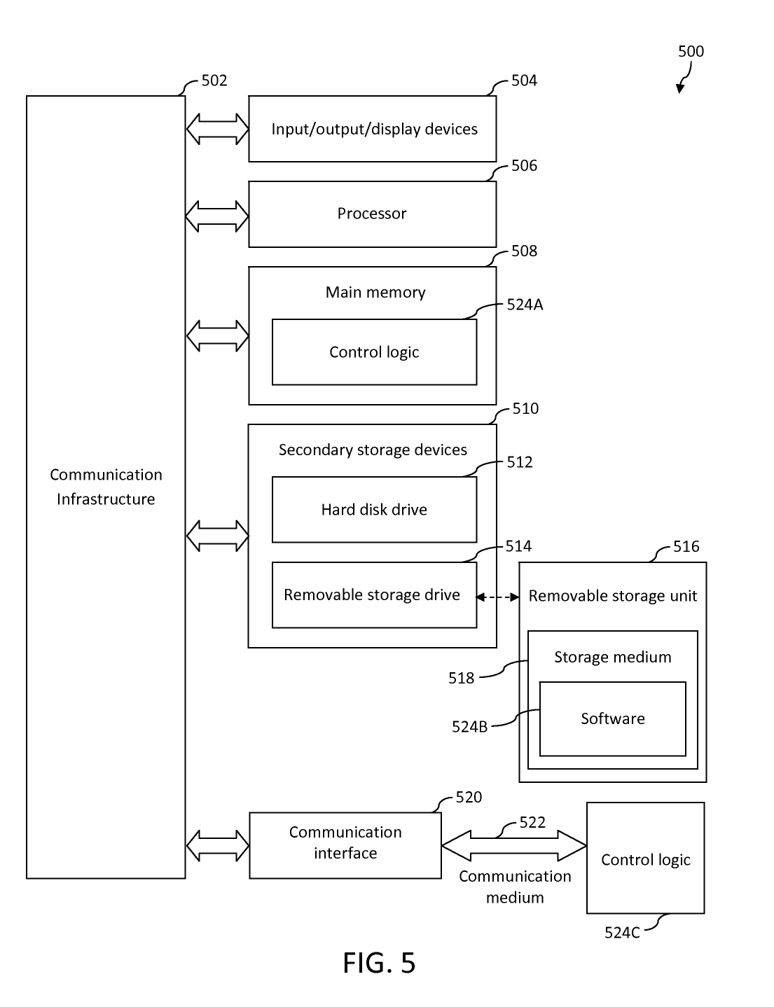

The embodiments described herein, including systems, methods/processes, and/or apparatuses, may be implemented using well known servers/computers, such as computer 500 shown in FIG. 5. For example, elements of example computer system 200, including any of the user systems 202A-202M depicted in FIG. 2 and any of the servers 206A-206N depicted in FIGS. 2 and 4 and elements thereof, and each of the steps of flowchart 300 depicted in FIGS. 3A-3C can each be implemented using one or more computers 500.

Computer 500 can be any commercially available and well known computer capable of performing the functions described herein, such as computers available from International Business Machines, Apple, Sun, HP, Dell, Cray, etc. Computer 500 may be any type of computer, including a desktop computer, a server, etc.

As shown in FIG. 5, computer 500 includes one or more processors (e.g., central processing units (CPUs)), such as processor 506. Processor 506 may include CAPTCHA market maker 208 of FIG. 2; receipt module 402, criteria determination module 404, key determination module 406, key removal module 408, modification module 410, reward determination module 412, provider module 414, user success determination module 416, comparison module 418, bot success determination module 420, reward module 422, payment module 424, and/or offer determination module 426 of FIG. 4; or any portion or combination thereof, for example, though the scope of the embodiments is not limited in this respect. Processor 506 is connected to a communication infrastructure 502, such as a communication bus. In some embodiments, processor 506 can simultaneously operate multiple computing threads.

Computer 500 also includes a primary or main memory 508, such as a random access memory (RAM). Main memory has stored therein control logic 524A (computer software), and data.

Computer 500 also includes one or more secondary storage devices 510. Secondary storage devices 510 include, for example, a hard disk drive 512 and/or a removable storage device or drive 514, as well as other types of storage devices, such as memory cards and memory sticks. For instance, computer 500 may include an industry standard interface, such as a universal serial bus (USB) interface for interfacing with devices such as a memory stick. Removable storage drive 514 represents a floppy disk drive, a magnetic tape drive, a compact disk drive, an optical storage device, tape backup, etc.

Removable storage drive 514 interacts with a removable storage unit 516. Removable storage unit 516 includes a computer useable or readable storage medium 518 having stored therein computer software 524B (control logic) and/or data. Removable storage unit 516 represents a floppy disk, magnetic tape, compact disc (CD), digital versatile disc (DVD), Blue-ray disc, optical storage disk, memory stick, memory card, or any other computer data storage device. Removable storage drive 514 reads from and/or writes to removable storage unit 516 in a well known manner.

Computer 500 also includes input/output/display devices 504, such as monitors, keyboards, pointing devices, etc.

Computer 500 further includes a communication or network interface 520. Communication interface 520 enables computer 500 to communicate with remote devices. For example, communication interface 520 allows computer 500 to communicate over communication networks or mediums 522 (representing a form of a computer useable or readable medium), such as local area networks (LANs), wide area networks (WANs), the Internet, etc. Network interface 520 may interface with remote sites or networks via wired or wireless connections. Examples of communication interface 522 include but are not limited to a modem, a network interface card (e.g., an Ethernet card), a communication port, a Personal Computer Memory Card International Association (PCMCIA) card, etc.

Control logic 524C may be transmitted to and from computer 500 via the communication medium 522.

Any apparatus or manufacture comprising a computer useable or readable medium having control logic (software) stored therein is referred to herein as a computer program product or program storage device. This includes, but is not limited to, computer 500, main memory 508, secondary storage devices 510, and removable storage unit 516. Such computer program products, having control logic stored therein that, when executed by one or more data processing devices, cause such data processing devices to operate as described herein, represent embodiments of the invention.

For example, each of the elements of example servers 206A-206N, including CAPTCHA market maker 208 depicted in FIG. 2; receipt module 402, criteria determination module 404, key determination module 406, key removal module 408, modification module 410, reward determination module 412, provider module 414, user success determination module 416, comparison module 418, bot success determination module 420, reward module 422, payment module 424, and offer determination module 426, each depicted in FIG. 4; and each of the steps of flowchart 300 depicted in FIGS. 3A-3C can be implemented as control logic that may be stored on a computer useable medium or computer readable medium, which can be executed by one or more processors to operate as described herein.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of providing a marketplace for CAPTCHA developers, comprising:
providing a plurality of instances of a proposed CAPTCHA and a plurality of instances of a reference CAPTCHA to a plurality of users of a computer system;
determining a first success rate that indicates a proportion of the plurality of instances of the proposed CAPTCHA that is solved by the users and a second success rate that indicates a proportion of the plurality of instances of the reference CAPTCHA that is solved by the users;
comparing the first success rate and the second success rate to determine a relationship therebetween;
determining a third success rate that indicates a proportion of a plurality of predetermined automated systems that solves the proposed CAPTCHA; and
determining a reward to be paid to a developer of the proposed CAPTCHA based on the third success rate and the relationship between the first and second success rates.

2. The method of claim 1, further comprising:
determining that the proposed CAPTCHA satisfies a plurality of predetermined criteria;
wherein providing the plurality of instances of the proposed CAPTCHA is performed in response to determining that the proposed CAPTCHA satisfies the plurality of predetermined criteria.

3. The method of claim 1, wherein comparing the first and second success rates comprises:
comparing the first and second success rates to determine that the first success rate is substantially same as or greater than the second success rate; and
wherein determining the reward to be paid to the developer of the proposed CAPTCHA comprises:
determining the reward to be paid to the developer of the proposed CAPTCHA based on the third success rate and further based on the first success rate being substantially the same as or greater than the second success rate.

4. The method of claim 1, further comprising:
determining a second reward to be paid to a developer of an automated system in the plurality of predetermined automated systems that solves the proposed CAPTCHA based on a number of automated systems in the plurality of predetermined automated systems that do not solve the proposed CAPTCHA.

5. The method of claim 1, further comprising:
offering to pay a predetermined amount to a developer of an automated system of the plurality of predetermined automated systems that is first to solve the proposed CAPTCHA;
wherein determining the third success rate is performed in response to offering to pay the predetermined amount.

6. The method of claim 5, wherein offering to pay the predetermined amount comprises:
offering to pay a predetermined amount, which increases with passage of time so long as the proposed CAPTCHA is not solved by an automated system of the plurality of predetermined automated systems, to a developer of an automated system of the plurality of predetermined automated systems that is first to solve the proposed CAPTCHA.

7. The method of claim 1, further comprising:
removing a key from the proposed CAPTCHA, the key being configured to assist an automated system to solve the proposed CAPTCHA;
wherein providing the plurality of instances of the proposed CAPTCHA is performed in response to removing the key from the proposed CAPTCHA.

8. The method of claim 1, further comprising:
receiving the proposed CAPTCHA from a developer of the proposed CAPTCHA;
modifying aspects of the proposed CAPTCHA that do not affect an appearance of the proposed CAPTCHA with respect to the users in response to receiving the proposed CAPTCHA from the developer;
wherein providing the plurality of instances of the proposed CAPTCHA is performed in response to modifying the aspects of the proposed CAPTCHA.

9. A server comprising:
a provider module configured to provide a plurality of instances of a proposed CAPTCHA and a plurality of instances of a reference CAPTCHA to a plurality of users of a computer system;
a user success determination module configured to determine a first success rate that indicates a proportion of the plurality of instances of the proposed CAPTCHA that is solved by the users and a second success rate that indicates a proportion of the plurality of instances of the reference CAPTCHA that is solved by the users;
a comparison module configured to compare the first success rate and the second success rate to determine a relationship therebetween;
a bot success determination module configured to determine a third success rate that indicates a proportion of a plurality of predetermined automated systems that solves the proposed CAPTCHA; and
a reward module configured to determine a reward to be paid to a developer of the proposed CAPTCHA based on the third success rate and the relationship between the first and second success rates.

10. The server of claim 9, further comprising:
a screener module configured to determine that the proposed CAPTCHA satisfies a plurality of predetermined criteria before the proposed CAPTCHA is provided to the plurality of users.

11. The server of claim 9, wherein the comparison module is configured to compare the first and second success rates to determine whether the first success rate is substantially same as or greater than the second success rate; and
wherein the reward module is configured to determine the reward to be paid to the developer of the proposed CAPTCHA in response to the first success rate being substantially the same as or greater than the second success rate.

12. The server of claim 9, wherein the reward module is further configured to determine a second reward to be paid to a developer of an automated system in the plurality of predetermined automated systems that solves the proposed CAPTCHA based on a number of automated systems in the plurality of predetermined automated systems that do not solve the proposed CAPTCHA.

13. The server of claim 9, wherein the provider module is further configured to provide an offer that specifies a second reward to be paid to a developer of an automated system of the plurality of predetermined automated systems that is first to solve the proposed CAPTCHA.

14. The server of claim 13, wherein the offer further specifies that the second reward increases with passage of time so long as the proposed CAPTCHA is not solved by an automated system of the plurality of predetermined automated systems.

15. The server of claim 9, further comprising:
a key removal module configured to remove a key from the proposed CAPTCHA before the proposed CAPTCHA is provided to the plurality of users;
wherein the key is configured to assist an automated system to solve the proposed CAPTCHA.

16. A computer program product comprising a computer-readable medium having computer program logic recorded thereon for enabling a processor-based system to provide a marketplace for CAPTCHA developers, comprising:
a first program logic module for enabling the processor-based system to provide a plurality of instances of a proposed CAPTCHA and a plurality of instances of a reference CAPTCHA to a plurality of users of a computer system;
a second program logic module for enabling the processor-based system to determine a first success rate that indicates a proportion of the plurality of instances of the proposed CAPTCHA that is solved by the users and a second success rate that indicates a proportion of the plurality of instances of the reference CAPTCHA that is solved by the users;
a third program logic module for enabling the processor-based system to compare the first success rate and the second success rate to determine a relationship therebetween; and
a fourth program logic module for enabling the processor-based system to determine a reward to be paid to a developer of the proposed CAPTCHA based on the relationship between the first and second success rates and further based on a third success rate that indicates a proportion of a plurality of predetermined automated systems that solves the proposed CAPTCHA.

17. The computer program product of claim 16, further comprising:
a fifth program logic module for enabling the processor-based system to determine that the proposed CAPTCHA satisfies a plurality of predetermined criteria before the proposed CAPTCHA is provided to the plurality of users.

18. The computer program product of claim 16, further comprising:
a fifth program logic module for enabling the processor-based system to determine a second reward to be paid to a developer of an automated system in the plurality of predetermined automated systems that solves the proposed CAPTCHA based on a number of automated systems in the plurality of predetermined automated systems that do not solve the proposed CAPTCHA.

19. The computer program product of claim 16, further comprising:
a fifth program logic module for enabling the processor-based system to provide an offer that specifies a second reward that is to be paid to a developer of an automated system of the plurality of predetermined automated systems that is first to solve the proposed CAPTCHA.

20. The computer program product of claim 16, further comprising:
a fifth program logic module for enabling the processor-based system to remove a key from the proposed CAPTCHA before the proposed CAPTCHA is provided to the plurality of users;
wherein the key is configured to assist an automated system to solve the proposed CAPTCHA.

21. A method of providing a marketplace for CAPTCHA developers, comprising:
providing a plurality of instances of a proposed CAPTCHA and a plurality of instances of a reference CAPTCHA to a plurality of users of a computer system;
determining a first success rate that indicates a proportion of the plurality of instances of the proposed CAPTCHA that is solved by the users and a second success rate that indicates a proportion of the plurality of instances of the reference CAPTCHA that is solved by the users;
comparing the first success rate and the second success rate to determine a relationship therebetween;
determining a third success rate that indicates a proportion of a plurality of predetermined automated systems that solves the proposed CAPTCHA; and
determining a reward to be paid to a developer of an automated system in the plurality of predetermined automated systems that solves the proposed CAPTCHA based on at least one of the third success rate or the relationship between the first and second success rates.

22. The method of claim 21, wherein determining the reward comprises:
determining the reward further based on the automated system that solves the proposed CAPTCHA being a first automated system in the plurality of predetermined automated systems to solve the proposed CAPTCHA.
